(19) United States
(12) Patent Application Publication
(10) Pub. No.: US 2011/0154234 A1
(43) Pub. Date: Jun. 23, 2011

(54) LAYOUT PROJECTION USING NON-LINEAR CONSTRAINTS

(75) Inventors: Fabian Omar Winternitz, Sammamish, WA (US); Kael R. Rowan, Kenmore, WA (US); Timothy Garry Dwyer, Seattle, WA (US); Stuart John Harding Kent, Kent (GB); George G. Robertson, Northeast Harbor, ME (US)

(73) Assignee: MICROSOFT CORPORATION, Redmond, WA (US)

(21) Appl. No.: 12/642,572

(22) Filed: Dec. 18, 2009

(51) Int. Cl. G06F 3/048

(52) U.S. Cl. 715/765; 715/769

(57) ABSTRACT

In an embodiment, a computer system instantiates an interactive layout system that is configured to display a layout with various diagram portions, where each diagram portion includes layout parts and corresponding constraints identifying how the layout parts of the diagram portion are to be displayed. The computer system receives input from a user indicating that at least one of the diagram portions is to be moved. The computer system determines the manner in which each diagram portion is to be moved based on the received user input. The moving includes rotating and/or scaling the diagram portions of the layout according to the received user input, such that the layout parts remain fixed in position relative to one another, but are scaled and/or rotated to fit the surrounding layout according to the corresponding constraints. The computer system dynamically moves the layout parts of the diagram portions according to the determination.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are designed to display diagrams, charts and other types of data presentations. Such software typically displays various nodes with lines or, more formally, “edges” connecting the nodes. The nodes may represent different diagram elements and the connecting edges may represent a link between the nodes. In some cases, when designing such a chart or diagram, a user may want to make changes to the positioning, scale or rotation of a selected node or group of nodes. Such position changes affect not only the repositioned node(s) but also the other nodes of the node diagram.

### BRIEF SUMMARY

Embodiments described herein are directed to dynamically updating an interactive layout system based on layout constraints and user inputs. In one embodiment, a computer system instantiates an interactive layout system that is configured to display a layout with various diagram portions, where each diagram portion includes layout parts and corresponding constraints identifying how the layout parts of the diagram portion are to be displayed. The computer system receives input from a user indicating that at least one layout part of at least one of the diagram portions is to be moved. The computer system determines the manner in which each diagram portion is to be moved based on the received user input. The moving includes repositioning, rotating and/or scaling at least one of the diagram portions of the layout according to the received user input, such that the layout parts remain fixed in position relative to one another, but are scaled and/or rotated to fit the surrounding layout according to the corresponding constraints. The computer system dynamically moves the layout parts of the diagram portions according to the determination.

In another embodiment, a computer system instantiates an interactive layout system that is configured to display a plurality of different diagram portions, where each diagram portion includes various layout parts and corresponding constraints identifying how the layout parts of the diagram portion are to be displayed. The different diagram portions include at least two diagram portions that are arranged according to different layout styles. The computer system receives input from a user indicating that at least one layout part of at least one of the diagram portions is to be moved. The computer system determines the manner in which each diagram portion is to be moved based on the received user input, where moving includes repositioning, rotating and/or scaling each of the different diagram portions of the layout according to the received user input, such that the layout parts remain fixed in position relative to one another, but are scaled and/or rotated to fit the surrounding layout according to the constraints and layout styles of each different diagram portion. The computer system dynamically moves the layout parts of the diagram portions according to the determination, where each diagram portion maintains an appropriate form based on the portion's corresponding constraints and layout style.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including dynamically updating an interactive layout system based on layout constraints and user inputs.

FIG. 2 illustrates a flowchart of an example method for dynamically updating an interactive layout system based on layout constraints and user inputs.

FIG. 3 illustrates a flowchart of an example method for dynamically updating an interactive layout system that includes different diagram portions with varying layout styles based on layout constraints and user inputs.

FIGS. 4A and 4B illustrate embodiments of the present invention in which a user selects and drags a layout part of a layout diagram.

### DETAILED DESCRIPTION

Embodiments described herein are directed to dynamically updating an interactive layout system based on layout constraints and user inputs. In one embodiment, a computer system instantiates an interactive layout system that is configured to display a layout with various diagram portions, where each diagram portion includes layout parts and corresponding constraints identifying how the layout parts of the diagram portion are to be displayed. The computer system receives input from a user indicating that at least one layout part of at least one of the diagram portions is to be moved. The computer system determines the manner in which each diagram portion is to be moved based on the received user input. The moving includes repositioning, rotating and/or scaling at least one of the diagram portions of the layout according to the received user input, such that the layout parts remain fixed in position relative to one another, but are scaled and/or rotated to fit the surrounding layout according to the corresponding constraints. The computer system dynamically moves the layout parts of the diagram portions according to the determination.

In another embodiment, a computer system instantiates an interactive layout system that is configured to display a plurality of different diagram portions, where each diagram portion includes various layout parts and corresponding constraints identifying how the layout parts of the diagram portion are to be displayed. The different diagram portions include at least two diagram portions that are arranged according to different layout styles. The computer system receives input from a user indicating that at least one layout part of at least one of the diagram portions is to be moved. The computer system determines the manner in which each diagram portion is to be moved based on the received user input, where moving includes repositioning, rotating and/or scaling each of the different diagram portions of the layout according to the received user input, such that the layout parts remain fixed in position relative to one another, but are scaled and/or rotated to fit the surrounding layout according to the constraints and layout styles of each different diagram portion. The computer system dynamically moves the layout parts of the diagram portions according to the determination, where each diagram portion maintains an appropriate form based on the portion's corresponding constraints and layout style.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, as discussed in greater detail below. Embodiments within the scope of the present invention also include physical and other computer-readable storage media for carrying or storing computer-executable instructions and/or data structures. Such computer-readable media can be any available media that can be accessed by a general purpose or special purpose computer system. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

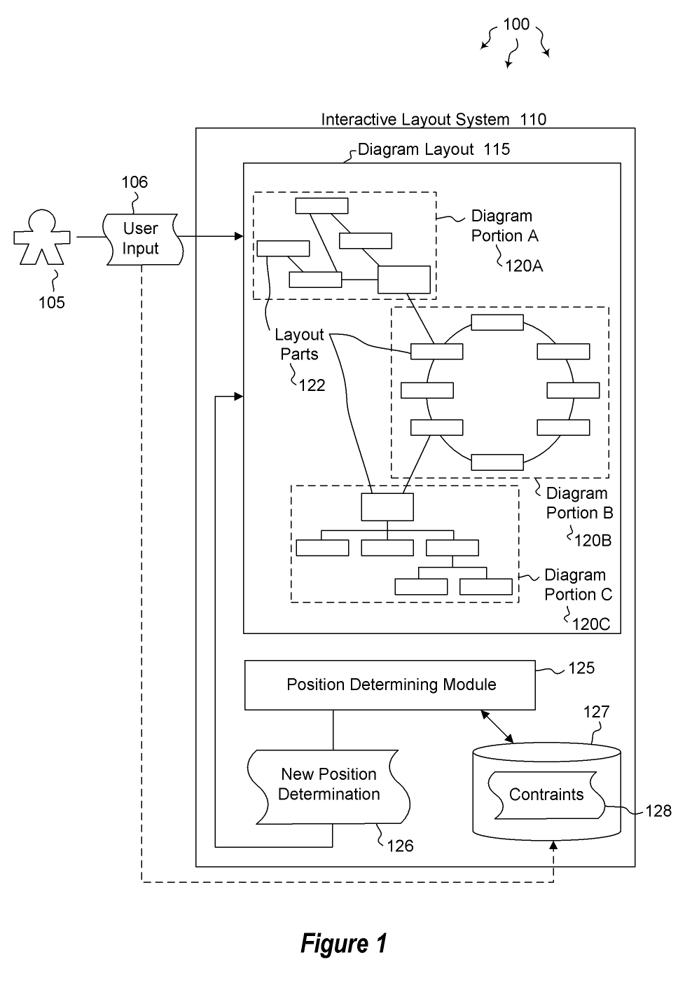

FIG. 1 illustrates a computer architecture 100 in which the principles of the present invention may be employed. Computer architecture 100 includes interactive layout system 110. Interactive layout system 110 (or “system 110” herein) may comprise any type of software application configured to present diagrams, charts or other presentation layouts. For instance, system 110 may be configured to display diagram layout 115. System 110 may also be configured to present and allow user editing of network or other node-link diagrams. Still further, interactive layout system 110 may be configured to allow user interaction with the displayed layout. For example, a user (e.g. user 105) may provide input 106 indicating that a portion of the diagram is to be changed in some manner. Such a change may include adding or removing layout elements, moving layout elements or changing the appearance of layout elements.

In one example, user 105 may indicate that a selected layout part (e.g. 122) is to be moved. The layout part may be selected and moved while the user drags the selected layout part. Interactive layout system 110 may be configured to dynamically update the diagram layout 115 as the user clicks and drags the layout part to various portions of the layout display. The non-selected portions of the diagram layout may, in turn, move with the selected part, but in a different manner. For instance, the other diagram layout parts may not move the exact distance or in the exact rotation of the selected layout part. As will be explained in greater detail below, the optimal movement and rotation for each individual diagram portion (e.g. 120A) may be determined separately. Moreover, each diagram portion may be moved independently of the other diagram portions, based on a determination of which amount of movement and/or rotation is optimal for that diagram portion.

Accordingly, position determining module 125 may be implemented to determine, based on user 105′s input 106, the optimal position for each diagram portion at any given moment. This determined optimal position may be continually re-determined as the user drags the selected layout part to different positions of the diagram layout display. This new position determination 126 may be communicated to the diagram layout display where the changes may be implemented in essentially real time. When determining an optimal position for a layout part or diagram portion, position determining module 125 may be configured to consult constraints 128 stored in a data store 127. These constraints may apply to a diagram portion or to an individual layout part. Thus, each diagram portion and/or layout part may have its own corresponding constraints.

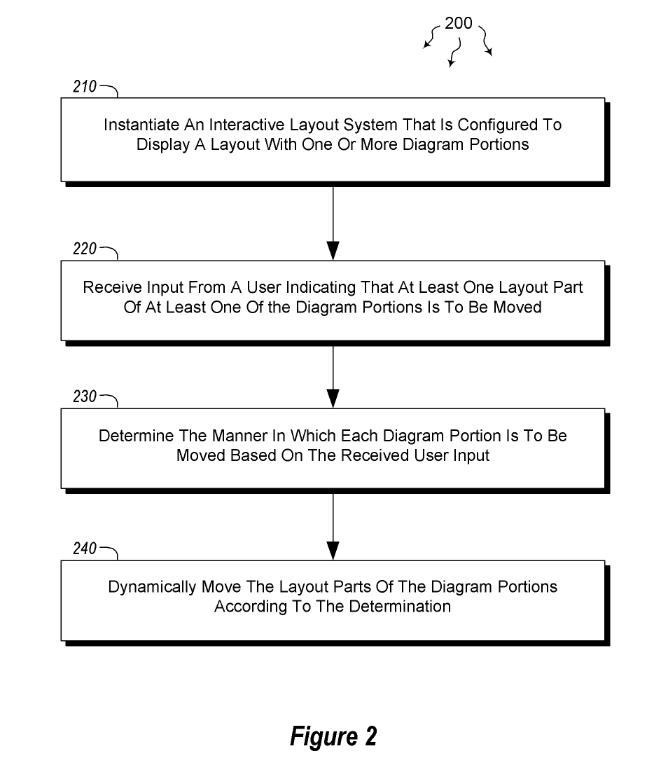

By way of example, these constraints may place limitations on how a given layout part or group of layout parts is to be displayed. For instance, constraints 128 may indicate that the layout parts of diagram portion A (120A) are to be displayed in a layered fashion. Constraints 128 may further indicate that the layout parts of diagram portion B (120B) are to be arranged in a circular form and that the layout parts of diagram portion C (120C) are to be arranged in a tree form. Thus, each diagram portion may maintain its general designated shape or layout type while individual layout parts are changed, moved or otherwise altered. It should also be noted that while three diagram portions are shown in diagram layout 115, more or fewer diagram portions may be implemented in a given diagram layout. Similarly, any number of layout parts or layout types may be used in a diagram layout. The interactive layout system 110 will be described in greater detail below with reference to method 200 of FIG. 2.

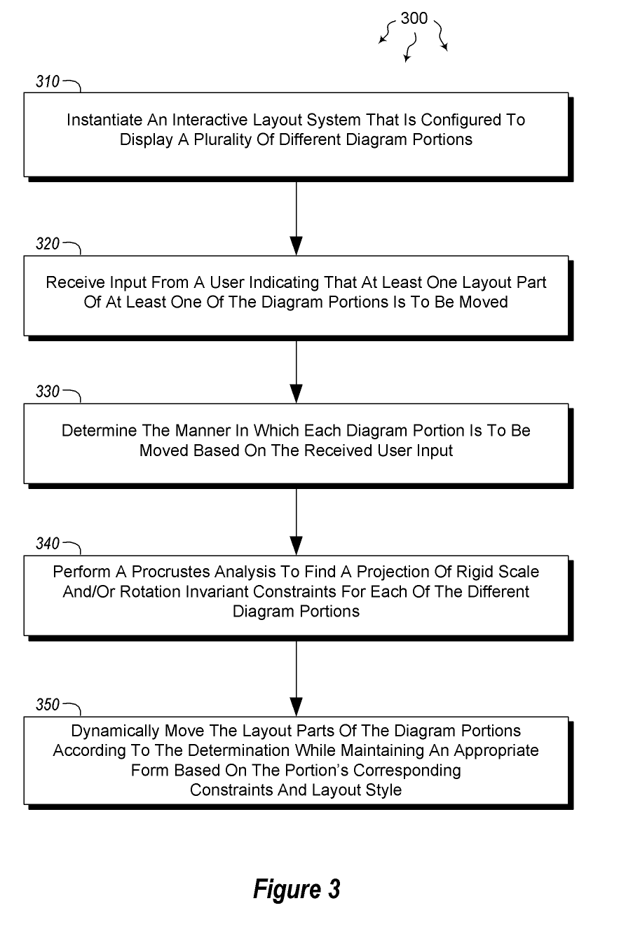

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

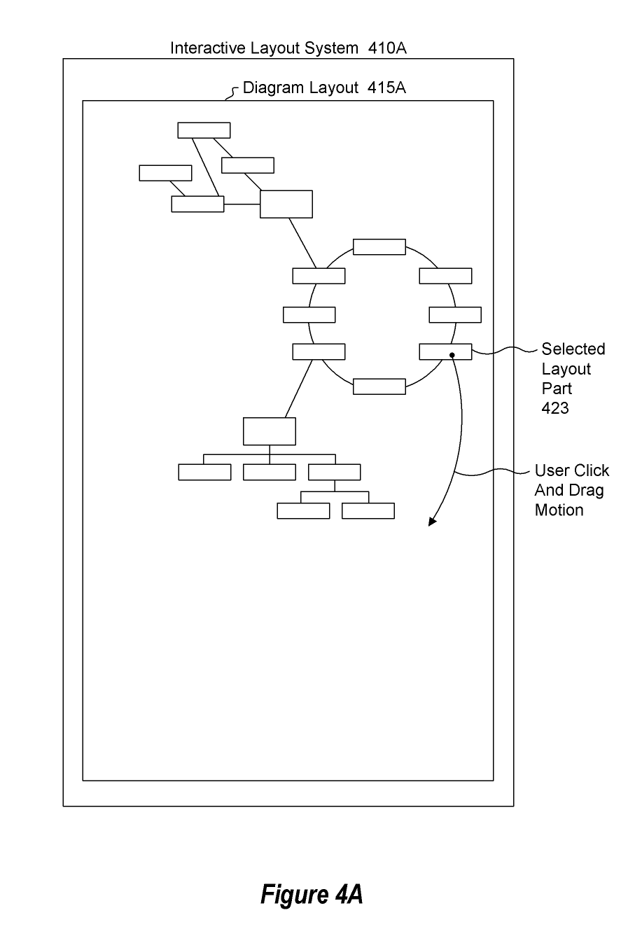

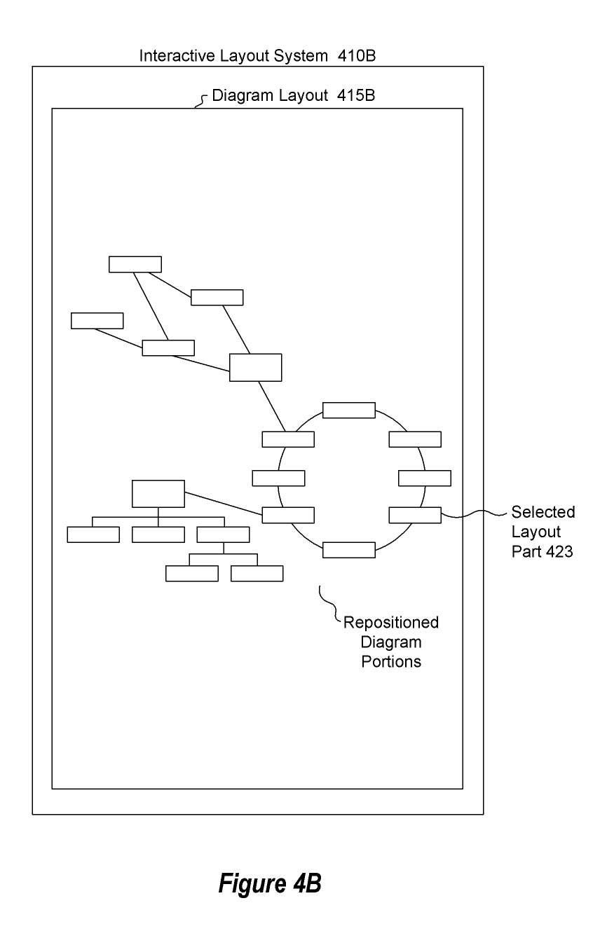

FIG. 2 illustrates a flowchart of a method 200 for dynamically updating an interactive layout system based on layout constraints and user inputs. The method 200 will now be described with frequent reference to the components and data of environment 100 and the interactive layout system of FIGS. 4A and 4B.

Method 200 includes an act of instantiating an interactive layout system that is configured to display a layout with one or more diagram portions, each diagram portion including one or more layout parts and corresponding constraints identifying how the layout parts of the diagram portion are to be displayed (act 210). For example, a computer system may instantiate interactive layout system 110 which is configured to display diagram layout 115 with diagram portions 120A, 120B and 120C. Each diagram portion includes various layout parts 122 and corresponding constraints 128 identifying how the layout parts of each diagram portion are to be displayed.

The diagram portion and/or layout part constraints may include various limitations or indications of how a particular portion is to be displayed. Such limitations may include a minimum radius for a circular diagram portion, a maximum radius, a minimum separation distance between layout parts of a diagram portion and a maximum separation distance between layout parts. Other constraints may indicate how tree nodes are to be displayed or how long particular links between nodes may be. Others may include horizontal and vertical alignment constraints. Many other constraints are possible and the examples provided above are not intended to limit the type or number of constraints that may be used within system 110.

In some cases, constraints for one diagram portion may affect other diagram portions of the layout. For instance, a minimum distance between nodes constraint for diagram portion A may prevent diagram portion B from coming within that distance of portion A, even if user input would indicate that the two are to be placed closer to one another. Moreover, constraints on individual layout parts or other layout elements may affect both the diagram portions that include the layout parts as well as other diagram portions within the diagram layout. Constraints may also be changed. Such constraint changes may occur while the interactive layout system is running and may be applied to the diagram layout in (essentially) real time.

Method 200 includes an act of receiving input from a user indicating that at least one layout part of at least one of the diagram portions is to be moved (act 220). For example, interactive layout system 110 may receive input 106 from user 105 indicating that at least one of layout parts 122 of diagram portions 120A-C is to be moved. Thus, as shown in FIG. 4A, in diagram layout 415A of interactive layout system 410A, a user may click or otherwise select (e.g. via touchscreen gesture) selected layout part 423. User 105 may then drag selected layout part 423 in a downward motion, indicating that part 423 is to be moved downward. As will be shown in steps below, the other portions of the diagram (and possibly other diagram portions) are moved along with the selected part, but not necessarily in lock step with the selected part.

Method 200 includes an act of determining the manner in which each diagram portion is to be moved based on the received user input, wherein moving includes at least one of repositioning, rotating and scaling at least one of the diagram portions of the layout according to the received user input, such that the layout parts remain fixed in position relative to one another, but are scaled and/or rotated to fit the surrounding layout according to the corresponding constraints (act 230). For example, position determining module 125 may determine the manner in which each diagram portion (e.g. portions 120A-C) is to be moved based on input 106, where moving includes repositioning, rotating and/or scaling at least one of the diagram portions (120A-C) of layout 115 according to the user input so that the various layout parts 122 remain fixed in position relative to each other, but are repositioned, scaled and/or rotated to fit the surrounding layout according to any corresponding constraints for the diagram portions.

Accordingly, in some embodiments, a diagram portion or portions may be moved according to the click and drag motions of a user. The various layout parts may be moved as the selected layout part is moved, but may be rotated and/or scaled differently based on the motions of the user. Thus, for instance, if the user drags the selected part and moves it quickly in some direction, the other diagram portions may be scaled down to appear smaller with (optionally) smaller or shorter links between nodes. These diagram portions may appear smaller while the selected element is being moved by the user and may re-enlarge or return to their original size after the user has stopped dragging the selected element. Similarly, when the user drags the selected element in a curved or other manner that changes directionality along multiple axes, various diagram portions may be rotated so as to be behind the element being dragged. Thus, as shown in diagram layout 415B of interactive layout system 410B, the upper and lower diagram portions (similar to portions A and C of FIG. 1) may be rotated and repositioned behind the selected layout part.

In some embodiments, a procrustes analysis may be used to find a projection of rigid scale and/or rotation invariant constraints that indicate how each diagram portion is to be moved or not moved when user inputs are received. A procrustes analysis is a technique for fitting an observed data configuration to an expected model using only linear transformations. Procrustes analyses are typically used to measure how much a researcher's results differ from an invariant model. As used herein, a procrustes analysis is used to move the various layout parts toward a given layout parts model (such as a circle, a tree, a line or other shape or layout type), but move each part as little as possible to satisfy constraints but still react to the user inputs. In this manner, a procrustes analysis can determine how to move a set of layout parts belonging to a diagram portion when a selected layout part of that diagram portion or another portion within the diagram layout is being moved.

In one example, determining the manner in which each diagram portion is to be moved based on the received user input 106 includes minimizing the least-squares displacement of a predefined arrangement of nodes in the layout to fit a target arrangement. Thus, position determining module 125 may calculate the least-squares displacement of, for example, diagram portion C in layout 115 to determine how that portion can be moved according to the user input while moving each portion as little as possible and while conforming to any appertaining constraints on diagram portion C.

Method 200 includes an act of dynamically moving the layout parts of the diagram portions according to the determination (act 240). For example, interactive layout system 110 may dynamically move the various layout parts 122 of the different diagram portions according to new position determination 126. New position determination 126 may indicate a new position for each layout part of the diagram layout. Accordingly, each part's position may be dynamically updated as inputs are received from the user. This updating includes scaling and/or rotating the layout parts of the various diagram portions in real time. The (continual) determinations made by module 125 ensure that the constraints for each layout part and/or diagram portions are satisfied, even as the constraints are changed.

In some cases, the lines connecting the diagram elements may be automatically redrawn as layout parts are selected and moved. This automatic redrawing of lines ensures that the layout maintains predetermined aesthetic standards. For instance, aesthetic standards may indicate that the lines between elements are to include as few bends and line crossings as possible. The lines may thus be automatically redrawn to conform to these standards. Moreover, as the user selects and drags a certain layout part or diagram portion, the diagram portions of the layout may be rotated around a fixed point chosen by the user. Additionally or alternatively, the diagram portions of the diagram layout may be rotated around a determined center of mass for the entire layout. Thus, in this manner, an interactive layout system may be dynamically updated based on based on user inputs while conforming to diagram layout constraints.

FIG. 3 illustrates a flowchart of a method 300 for dynamically updating an interactive layout system that includes different diagram portions with varying layout styles based on layout constraints and user inputs. The method 300 will now be described with frequent reference to the components and data of environment 100 and the interactive layout system of FIGS. 4A and 4B.

Method 300 includes an act of instantiating an interactive layout system that is configured to display a plurality of different diagram portions, each diagram portion including one or more layout parts and corresponding constraints identifying how the layout parts of the diagram portion are to be displayed, wherein the plurality of different diagram portions comprises at least two diagram portions that are arranged according to different layout styles (act 310). For example, a computer system may instantiate interactive layout system 110 that is configured to display multiple different diagram portions (120A-C), where each diagram portion includes one or more layout parts and corresponding constraints identifying how the layout parts 122 of the diagram portion are to be displayed. In some embodiments, the diagram portions include at least two diagram portions that are arranged according to different layout styles (e.g. circular, tree, layered, etc.).

In some cases, a user may specify how each diagram portion is to appear. The user may select from various different types of automatic layout which are then applied to a selected group of layout parts. In such cases, the layout of the interactive layout system 110 seamlessly integrates the different diagram portions arranged according to various specified types of automatic layout. Accordingly, a single layout may include many different layout types, all seamlessly integrated such that when a layout part of one diagram portion is changed or moved, the other diagram portions (regardless of their layout type) can be dynamically moved or changed in line with their corresponding constraints. Automatic layouts may include layered layouts, orthogonal layouts or fixed-geometry layouts including shapes such as circles, squares or other linear or non-linear shapes. All types of layouts may be combined and displayed, edited and updated within diagram layout 115.

Method 300 includes an act of receiving input from a user indicating that at least one layout part of at least one of the diagram portions is to be moved (act 320). For example, interactive layout system 110 may receive input 106 from user 105 indicating that at least one of layout parts 122 of diagram portions 120A-C is to be moved, as generally shown in FIG. 4A.

Method 300 further includes an act of determining the manner in which each diagram portion is to be moved based on the received user input, wherein moving includes at least one of repositioning, rotating and scaling each of the different diagram portions of the layout according to the received user input, such that the layout parts remain fixed in position relative to one another, but are scaled and/or rotated to fit the surrounding layout according to the constraints and layout styles of each different diagram portion (act 330).

For example, position determining module 125 may determine the manner in which each diagram portion (e.g. portions 120A-C) is to be moved based on received input 106, where moving includes repositioning, rotating and/or scaling the diagram portions of layout 115 according to the user input so that the various layout parts 122 remain fixed in position relative to each other, but are repositioned, scaled and/or rotated to fit the surrounding layout according to any corresponding constraints and layout styles for each different diagram portion. The new determined position 126 may be for a single layout part, a single diagram portion or for a plurality of different layout parts and diagram portions. Moreover, new positions may be determined periodically according to a user-defined or administrator-defined refresh rate. These new positions may provide incremental movements for each layout part, such that the movements appear seamless and fluid to the user.

Method 300 includes an act of performing a procrustes analysis to find a projection of rigid scale and/or rotation invariant constraints for each of the different diagram portions (act 340). For example, position determining module 125 may perform a procrustes analysis to find a projection of rigid scale and/or rotation invariant constraints for each of the different diagram portions. This projection allows an optimal movement to be determined for each layout part and/or diagram portion. The projection determines how the constraints can be followed for each diagram portion while moving each part as little as possible and still carrying out the user's provided input. The use of a procrustes analysis allows fast processing of movement determinations and allows multiple different layouts of different layout types to be moved and otherwise altered in real time, as inputs are received from the user.

Method 300 includes an act of dynamically moving the layout parts of the diagram portions according to the determination, wherein each diagram portion maintains an appropriate form based on the portion's corresponding constraints and layout style (act 350). For example, interactive layout system 110 may dynamically move layout parts 122 of diagram portions 120A-C according to new position determination 126 which includes the projection calculated by procrustes analysis. In this manner, each diagram portion maintains an appropriate form based on the portion's corresponding constraints and layout style.

Accordingly, an interactive layout system may be provided that presents a diagram layout with various layout parts and diagram portions and allows users to move and change these elements dynamically in real time. Moreover, the interactive layout system allows multiple diagram portions of varying types to be displayed in a single layout and allows each diagram portion to maintain its relative shape while being moved by a user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including a processor and a memory, a computer-implemented method for dynamically updating an interactive layout system based on layout constraints and user inputs, the method comprising:
an act of instantiating an interactive layout system that is configured to display a layout with one or more diagram portions, each diagram portion including one or more layout parts and corresponding constraints identifying how the layout parts of the diagram portion are to be displayed;
an act of receiving input from a user indicating that at least one layout part of at least one of the diagram portions is to be moved;
an act of determining the manner in which each diagram portion is to be moved based on the received user input, wherein moving includes at least one of repositioning, rotating and scaling at least one of the diagram portions of the layout according to the received user input, such that the layout parts remain fixed in position relative to one another, but are scaled and/or rotated to fit the surrounding layout according to the corresponding constraints; and
an act of dynamically moving the layout parts of the diagram portions according to the determination.

2. The method of claim 1, wherein the layout, including the layout parts of the various diagram portions, is scaled and/or rotated in essentially real time.

3. The method of claim 1, wherein at least one individual layout part is selected and dragged by the user, indicating that the selected layout part is to be moved according to the user's dragging motion.

4. The method of claim 3, wherein the layout is incrementally and continuously updated according to the user's dragging motion while ensuring that the constraints of each diagram portion are satisfied.

5. The method of claim 4, wherein the lines connecting the diagram elements are automatically redrawn as the layout is moved to ensure that the layout maintains predetermined aesthetic standards.

6. The method of claim 1, wherein the interactive layout system is configured for editing and presenting network diagrams.

7. The method of claim 1, wherein a procrustes analysis is used to find a projection of rigid scale and/or rotation invariant constraints.

8. The method of claim 1, wherein one or more of the constraints are changeable by the user while the interactive layout system is running.

9. The method of claim 8, wherein any changes made to the constraints by the user are applied to the layout in essentially real time.

10. The method of claim 1, wherein determining the manner in which each diagram portion is to be moved based on the received user input comprises minimizing the least-squares displacement of a predefined arrangement of nodes in the layout to fit a target arrangement.

11. The method of claim 1, wherein the constraints comprise at least one of a minimum radius, a maximum radius, a minimum separation distance between layout parts and a maximum separation distance between layout parts.

12. The method of claim 1, wherein the constraints for one diagram portion affect at least one other diagram portion of the layout.

13. The method of claim 1, wherein the diagram portions of the layout rotate around a fixed point chosen by the user.

14. The method of claim 1, wherein the diagram portions of the layout rotate around a determined center of mass for the entire layout.

15. A computer program product for implementing a method for dynamically updating an interactive layout system that includes different diagram portions with varying layout styles based on layout constraints and user inputs, the computer program product comprising one or more computer-readable storage media having stored thereon computer-executable instructions that, when executed by one or more processors of the computing system, cause the computing system to perform the method, the method comprising:
an act of instantiating an interactive layout system that is configured to display a plurality of different diagram portions, each diagram portion including one or more layout parts and corresponding constraints identifying how the layout parts of the diagram portion are to be displayed, wherein the plurality of different diagram portions comprises at least two diagram portions that are arranged according to different layout styles;
an act of receiving input from a user indicating that at least one layout part of at least one of the diagram portions is to be moved;
an act of determining the manner in which each diagram portion is to be moved based on the received user input, wherein moving includes at least one of repositioning, rotating and scaling each of the different diagram portions of the layout according to the received user input, such that the layout parts remain fixed in position relative to one another, but are scaled and/or rotated to fit the surrounding layout according to the constraints and layout styles of each different diagram portion;
an act of performing a procrustes analysis to find a projection of scale and/or rotation invariant constraints for each of the different diagram portions; and
an act of dynamically moving the layout parts of the diagram portions according to the determination, wherein each diagram portion maintains an appropriate form based on the portion's corresponding constraints and layout style.

16. The computer program product of claim 15, wherein at least one of the plurality of different diagram portions is arranged according to a specified type of automatic layout.

17. The computer program product of claim 16, wherein the layout of the interactive layout system seamlessly integrates the plurality of different diagram portions arranged according to various specified types of automatic layout.

18. The computer program product of claim 15, wherein the automatic layout type comprises a layered layout.

19. The computer program product of claim 15, wherein the automatic layout type comprises an orthogonal layout.

20. A computer system comprising the following:
one or more processors;
system memory;
one or more computer-readable storage media having stored thereon computer-executable instructions that, when executed by the one or more processors, causes the computing system to perform a method for dynamically updating an interactive layout system based on layout constraints and user inputs, the method comprising the following:
an act instantiating an interactive layout system, wherein the interactive layout system is configured to display a layout with one or more diagram portions, each diagram portion including one or more layout parts and corresponding constraints identifying how the layout parts of the diagram portion are to be displayed;
an act of receiving input from a user indicating that at least one of the diagram portions is to be moved;
an act of determining the manner in which each diagram portion is to be moved based on the received user input, wherein moving includes at least one of rotating and scaling the diagram portions of the layout according to the received user input, such that the layout parts remain fixed in position relative to one another, but are scaled and/or rotated to fit the surrounding layout according to the corresponding constraints; and
an act of dynamically moving the layout parts of the diagram portions according to the determination.
